(19) United States
(12) Patent Application Publication
(10) Pub. No.: US 2017/0223452 A1
(43) Pub. Date: Aug. 3, 2017

(54) SOUND SIGNAL PROCESSING APPARATUS, SYSTEM, AND METHOD

(71) Applicant: YAMAHA CORPORATION, Hamamatsu-shi (JP)

(72) Inventors: Kazunobu KONDO, Toyohashi-shi (JP); Takuya FUJISHIMA, Hamamatsu-shi (JP); Yoshifumi OIZUMI, Hamamatsu-shi (JP); Risa FUKUDA, Hamamatsu-shi (JP); Takahiro AKABANE, Hamamatsu-shi (JP)

(21) Appl. No.: 15/488,253

(22) Filed: Apr. 14, 2017

Related U.S. Application Data
(63) Continuation of application No. PCT/JP2015/079365, filed on Oct. 16, 2015.

(30) Foreign Application Priority Data
Oct. 17, 2014 (JP) 2014-212416

(51) Int. Cl. H04R 3/00; H04R 29/00; H04H 60/04

(52) U.S. Cl. CPC H04R 3/005; H04H 60/04; H04R 29/008

(57) ABSTRACT

A sound signal processing apparatus and system includes a control device having a processor and a memory storing instructions that causes the processor to acquire a plurality of sound signals representing sounds recorded at a plurality of positions in a sound space, respectively, and correlate the plurality of sound signals with a plurality of pieces of position information indicating the recording positions, respectively. Sound signals, from among the acquired plurality of signals correlated with the plurality of pieces of position information, are selected as a mixing target. The selected sound signals are mixed to be synchronized with each other.

### CROSS REFERENCE TO RELATED APPLICATION(S)

This application is a continuation of International Patent Application No. PCT/JP2015/079365 filed on Oct. 16, 2015 which claims the priority of Japanese Patent Application No. 2014-212416 filed on Oct. 17, 2014, the contents of which are incorporated herein by reference in its entirety.

### BACKGROUND

Sound combining apparatuses for combining sound signals that have been recorded at a plurality of different positions are known. See for example Patent Literature 1 (JP-A-2009-300576). In the sound combining apparatus disclosed in Patent Literature 1, a recording device stores sound data representing sounds picked up at different positions in a space. A setting unit sets the position of a sound receiving point variably according to an instruction from a user. A sound combining unit combines sounds by processing a plurality of sound data individually according to relationships between positions of sound pick-up points corresponding to the respective sound data and the position of the sound receiving point.

In the sound combining apparatus disclosed in Patent Literature 1, in the case where a large number of sound data are stored in the storage device, work of selecting a plurality of sound data to be combined together from the large number of sound data may be complicated.

There remains a need for a sound signal processing apparatus and a sound signal processing method capable of selecting a plurality of sound signals easily and mixing them together. The present development addresses this need.

### SUMMARY OF THE INVENTION

One aspect of the present invention is a sound signal processing apparatus having a control device. The control device includes a memory storing instructions and a processor configured to implement the instructions stored in the memory and execute an acquiring task, a selecting task, and a mixing task. The acquiring task acquires a plurality of sound signals representing sounds recorded at a plurality of positions in a sound space, respectively, and correlates the acquired plurality of sound signals with a plurality of pieces of position information indicating the recording positions, respectively. The selecting task selects, as a mixing target, sound signals from among the acquired plurality of sound signals correlated with the plurality of pieces of position information. The mixing task mixes together the selected sound signals to be synchronized with each other.

The selecting task can present the plurality of pieces of position information, detect a manipulation of selection from among the presented plurality of pieces of position information, and select a sound signal corresponding to selected position information, from among the presented plurality of pieces of position information, in response to detection of the selection manipulation.

The selecting task can displays the presented plurality of pieces of position information in a map image, and in detecting the manipulation of selection, detect a manipulation of selection, from among the presented plurality of pieces of position information, in the map image.

The processor is further configured to execute a setting task and an extracting task. The setting task can set a sound signal extraction condition, and the extracting task can extract a sound signal and position information that satisfy the extraction condition from among the plurality of sound signals and the presented plurality of pieces of position information. The selecting task can present the extracted position information as the presented plurality of pieces of position information.

The processor is further configured to execute a time acquiring task that can acquire time information indicating a recording time for each sound signal, and correlate the time information with the respective sound signal. The setting task can set a time condition relating to a sound recording time as the extraction condition. The extracting task can extract the sound signal and position information that satisfy the time condition.

The processor is further configured to execute a reproducing task that can reproduce the selected sound signal.

Another aspect is a method for the sound signal processing apparatus described above. The method can include an acquiring step, a selecting step, and a mixing step corresponding the acquiring task, the selecting task, and the mixing task described above. Specifically, the acquiring step can acquire a plurality of sound signals representing sounds recorded at a plurality of positions in a sound space, respectively, and correlate the acquired plurality of sound signals with a plurality of pieces of position information indicating the recording positions, respectively. The selecting step can select, as a mixing target, sound signals from among the plurality of sound signals correlated with the plurality of pieces of position information. The mixing step can mix together the selected sound signals to be synchronized with each other.

Another aspect is a sound signal processing system comprising a plurality of terminal apparatuses, and the sound signal processing apparatus described above. The acquiring task acquires a plurality of sound signals representing sounds recorded at a plurality of positions in a sound space, respectively, from the plurality of terminal apparatuses, and correlates the acquired plurality of sound signals with a plurality of pieces of position information indicating the recording positions acquired from the plurality of terminal apparatuses, respectively.

The present development makes it possible to select from among a plurality of sound signals easily based on a plurality of pieces of position information and to mix the selected sound signals together.

### BRIEF DESCRIPTION OF THE DRAWINGS

FIG. 1 is a block diagram showing the configuration of a sound signal processing system according to an embodiment of the present invention.

FIG. 2 is a block diagram showing the configuration of a terminal apparatus.

FIG. 3 is a block diagram showing the configuration of a synchronous mixing apparatus.

FIG. 4 is a schematic diagram showing the structure of recorded data that are stored in a database.

FIG. 5 is a block diagram showing the functional configuration of the synchronous mixing apparatus.

FIG. 6A is a diagram showing an example of a map image and recording marks that are displayed on a touch panel display of the synchronous mixing apparatus.

FIG. 6B is a diagram showing another example of a map image and recording marks that are displayed on the touch panel display of the synchronous mixing apparatus.

FIG. 6C is a diagram showing a further example of a map image and recording marks that are displayed on the touch panel display of the synchronous mixing apparatus.

FIG. 7 is a flowchart illustrating an operation of the terminal apparatus.

FIG. 8 is a flowchart illustrating an operation of the terminal apparatus.

FIG. 9 schematically shows the control device 10, 30.

### DETAILED DESCRIPTION OF THE EXEMPLARY EMBODIMENTS

The present development relates to a sound signal processing apparatus and a sound signal processing method of combining sound signals recorded at a plurality of positions.

A sound signal processing system according to an embodiment of the present invention will be hereinafter described in detail with reference to the drawings.

### (1) Sound Signal Processing System

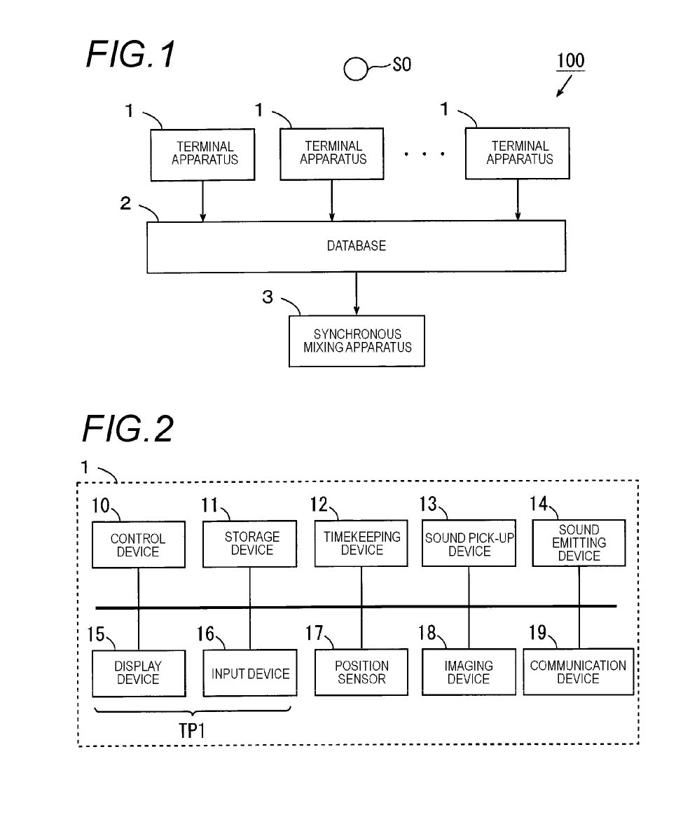

FIG. 1 is a block diagram showing the configuration of the sound signal processing system according to the embodiment of the present invention. The sound signal processing system 100 shown in FIG. 1 includes a plurality of terminal apparatuses 1, a database 2, and a synchronous mixing apparatus 3. The plurality of terminal apparatuses 1 are used for recording a sound that is emitted from a sound emitting source S0 in a musical hall, a sound space such as an outdoor concert place or a recording studio. For example, the sound emitting source S0 is one or more musical instruments or singers. For example, a sound is a playing sound of a musical instrument(s), a singing voice of a singer(s). The sound space is a space within a reachable range of a sound emitted from the sound emitting source S0.

A portable apparatus such as a cell phone, a smartphone, or a tablet terminal can be used as each terminal apparatus 1. Sound signals representing sounds recorded by the respective terminal apparatuses 1 are stored in the database 2 together with pieces of positions information indicating respective recording positions. The details of the terminal apparatus 1 will be described later. The database 2 is implemented in a server such as a web server. The synchronous mixing apparatus 3 mixes a plurality of sound signals stored in the database 2 while synchronizing them with each other. A personal computer, a smartphone, a tablet terminal, a server, or the like can be used as the synchronous mixing apparatus 3. The details of the synchronous mixing apparatus 3 will be described later.

FIG. 2 is a block diagram showing the configuration of the terminal apparatus 1. The terminal apparatus 1 includes a control device 10, a storage device 11, a timekeeping device 12, a sound pick-up device 13, a sound emitting device 14, a display device 15, an input device 16, a position sensor 17, an imaging device 18, and a communication device 19. The control device 10 includes a CPU (central processing unit) and a memory, for example. The storage device 11 includes a storage medium such as a hard disk, an optical disc, a magnetic disk, or a memory card. A data acquisition processing program (described later) and a plurality of recorded data (described later) are stored in the storage device 11. The data acquisition processing program can be provided being delivered over a communication network such as a telephone network or the Internet and then installed in the storage device 11. The control device 10 performs data acquisition processing by running the data acquisition processing program stored in the storage device 11.

The timekeeping device 12 includes a timer or the like and generates a current time as time information. The sound pick-up device 13, which includes a microphone or the like, gathers sound in the sound space and generates a sound signal representing the sound. The sound emitting device 14 includes speakers, headphones, or the like and emits a sound based on a sound signal.

The display device 15 is a liquid crystal display device, an organic EL (electroluminescence) display device, or the like. The input device 16 includes various buttons, a keyboard, a mouse, etc. In the embodiment, the display device 15 and the input device 16 are integrated together to form a touch panel display TP1. The position sensor 17 is, for example, a GPS (global positioning system) device and generates position information indicating a current position of the terminal apparatus 1. The imaging device 18 includes a CCD (charge-coupled device) camera or the like and generates image data by imaging.

The communication device 19 sends recorded data to the database 2 over a communication network such as a telephone network or the Internet. The communication device 19 can communicate with another terminal apparatus 1 over the communication network. Furthermore, the communication device 19 can perform a short-range wireless communication with another terminal apparatus 1 existing in the sound space by a communication scheme such as Bluetooth (registered trademark) or Wi-Fi (registered trademark).

Sound signals generated by the sound pick-up device 13, pieces of position information generated by the position sensor 17, pieces of time information generated by the timekeeping device 12, and tags assigned by a user manipulation are stored in the storage device 11 as recorded data.

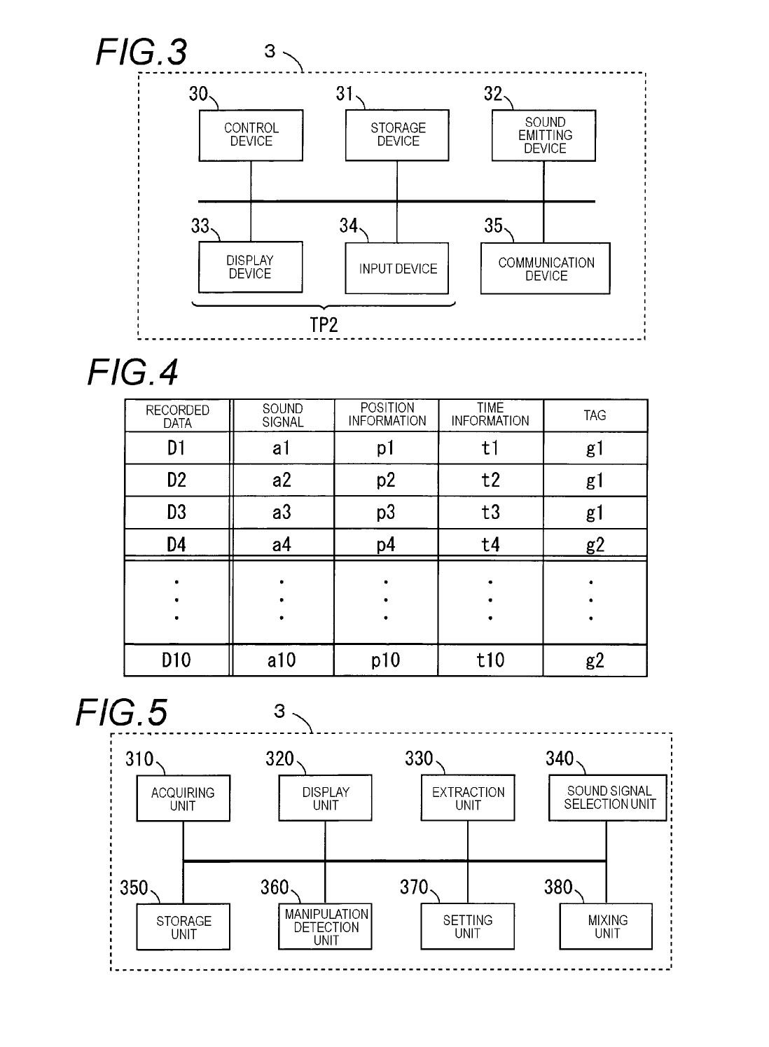

FIG. 3 is a block diagram showing the configuration of the synchronous mixing apparatus 3. The synchronous mixing apparatus 3 includes a control device 30, a storage device 31, a sound emitting device 32, a display device 33, an input device 34, and a communication device 35. The configurations of the control device 30, the storage device 31, the sound emitting device 32, the display device 33, the input device 34, and the communication device 35 are similar to those of the control device 10, the storage device 11, the sound emitting device 14, the display device 15, the input device 16, and the communication device 19 of each terminal apparatus 1, respectively. In this respect, the control device 30 also includes a CPU and a memory like the control device 10. In the embodiment, the display device 33 and the input device 34 are integrated together to form a touch panel display TP2.

A synchronous mixing processing program (described later) and a plurality of recorded data acquired from the terminal apparatus 1 are stored in the storage device 31. The synchronous mixing processing program can be provided being delivered over a communication network such as a telephone network or the Internet and then installed in the storage device 31. The control device 10 performs synchronous mixing processing by running the synchronous mixing processing program stored in the storage device 31. The communication device 35 acquires recorded data from the database 2 over a communication network such as a telephone network or the Internet. The communication device 35 can communicate with each terminal apparatus 1 over the communication network. The communication device 35 can perform a short-range wireless communication with each terminal apparatus 1 existing in the sound space.

(2) Recorded Data

FIG. 4 is a schematic diagram showing the structure of recorded data that are stored in the database 2. A plurality of recorded data that are sent from the plurality of terminal apparatuses 1 are stored in the database 2. As shown in FIG. 4, each piece of recorded data includes a sound signal, position information, time information, and a tag. In the example of FIG. 4, recorded data D1-D10 are stored in the storage device 31. The recorded data D1-D10 include sound signals a1-a10, pieces of position information p1-p10, and time information t1-t10, respectively. The recorded data D1-D3 include a common tag g1 and the recorded data D4-D10 include a common tag g2. Recorded data can include image data generated by the imaging device 18 of the terminal apparatus 1.

Each sound signal can be either sound data that consists of a plurality of sampling values produced by sampling a waveform signal of a sound at a predetermined sampling cycle or a signal of another form such as MIDI (Musical Instrument Digital Interface) data. Each piece of position information is data indicating a position where a terminal apparatus 1 is located at the time of recording of a sound signal, and can be an absolute position of the terminal apparatus 1 or the position relative to another terminal apparatus 1. Each piece of time information includes a start date and time and end date and time of recording of a sound signal. Each tag, which indicates a group of sound signals, is assigned by a user manipulation. Tags can be assigned to respective recorded data automatically in the database 2 by performing a similarity analysis on sound signals. In this case, a common tag is assigned to sound signals having a preset similarity.

### (3) Functional Configuration of Synchronous Mixing Apparatus 3

FIG. 5 is a block diagram showing the functional configuration of the synchronous mixing apparatus 3. The functions of an acquiring unit 310, a display unit 320, an extraction unit 330, a sound signal selection unit 340, a storage unit 350, a manipulation detection unit 360, a setting unit 370, and a mixing unit 380 which are shown in FIG. 5 are realized as a result of execution of the synchronous mixing processing program stored in the storage device 31 by the control device 30 shown in FIG. 1.

The acquiring unit 310 acquires recorded data from the database shown in FIG. 1. The storage unit 350 stores the recorded data acquired by the acquiring unit 310. The display unit 320 causes the touch panel display TP2 to display a map image and recording marks. The manipulation detection unit 360 detects a user manipulation made by using the touch panel display TP2. The setting unit 370 sets an extraction condition. The extraction unit 330 extracts recorded data that satisfy the extraction condition from the recorded data stored in the storage unit 350. The sound signal selection unit 340 selects some of the recorded data extracted by the extraction unit 330, according to a user manipulation. The mixing unit 380 performs synchronous mixing processing on sound signals of selected recorded data.

### (4) Display of Map Image and Recording Marks

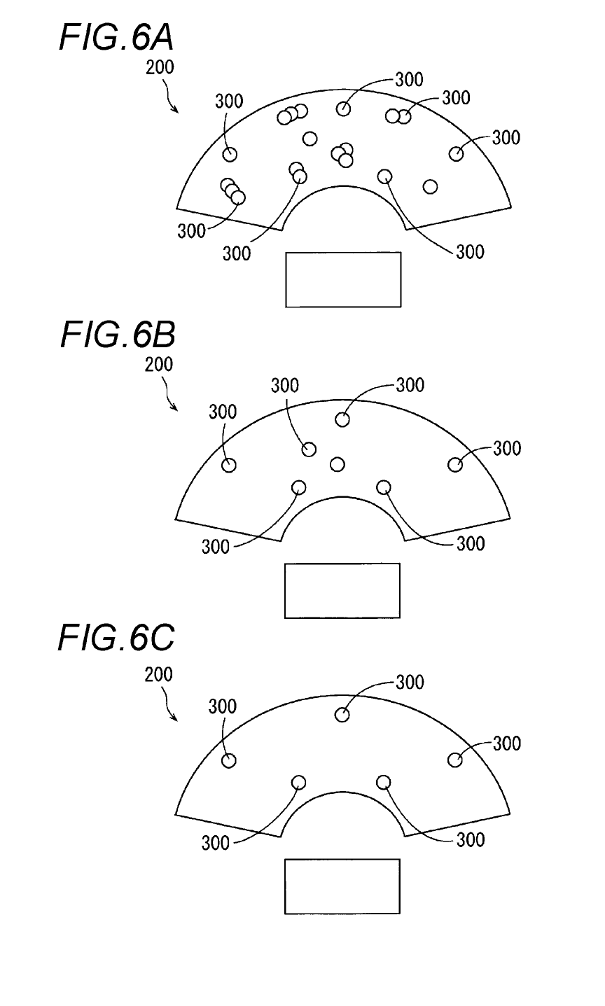

FIGS. 6A, 6B, and 6C are diagrams showing examples of a map image and recording marks that are displayed on the touch panel display TP2 of the synchronous mixing apparatus 3. In the examples of FIGS. 6A, 6B, and 6C, a map image 200 including an outdoor concert place is displayed.

As shown in FIG. 6A, recording marks 300 are displayed at recording positions of sound signals of the plurality of terminal apparatuses 1. In the initial state, recording marks 300 located within the range of the map image 200 among the recording marks 300 corresponding to the plurality of recorded data that are stored in the storage device 31 of the synchronous mixing apparatus 3 are displayed. When recording events occurred on a plurality of different date and times at the same position, a plurality of recording marks 300 are displayed at the same position in an overlapped manner.

When a user specifies an extraction condition, recorded data that satisfy the extraction condition are extracted. Then the recording marks 300 corresponding to the extracted recorded data are displayed as shown in FIG. 6B. Furthermore, when the user selects part of the displayed recording marks 300, only the selected recording marks 300 are displayed as shown in FIG. 6C. As described below, synchronous mixing processing is performed on the plurality of sound signals corresponding to the plurality of selected recording marks 300.

### (5) Operation of Terminal Apparatus 1

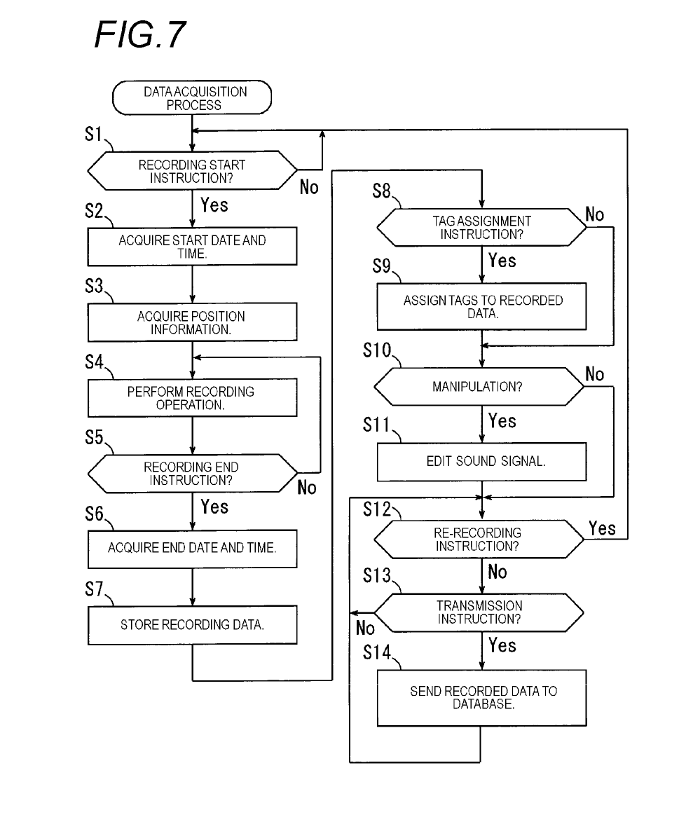

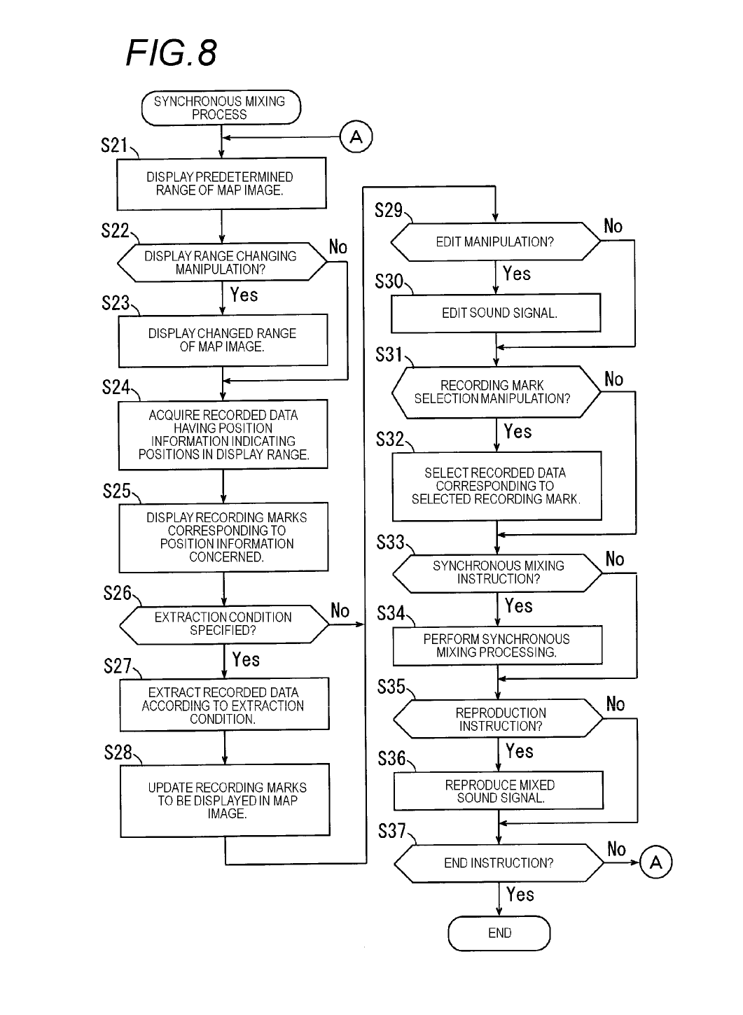

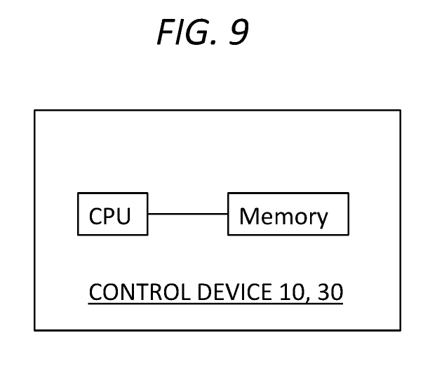

FIGS. 7 and 8 are flowcharts illustrating a data acquisition process of the terminal apparatus 1 shown in FIG. 2. First, the control device 10 shown in FIG. 2 judges whether a recording start instruction of a user has been detected by the touch panel display TP1 (step S1). If a recording start instruction has been detected, the control device 10 acquires, as a start date and time, a current time that is generated by the timekeeping device 12 (step S2). Furthermore, the control device 10 acquires position information that is generated by the position sensor 17 (step S3) and performs an operation of recording a sound signal generated by the sound pick-up device 13 (step S4).

Subsequently, the control device 10 judges whether a recording end instruction of the user has been detected by the touch panel display TP1 (step S5). If no recording end instruction has been detected, the control device 10 returns to step S4 and continues the recording operation. If a recording end instruction has been detected, the control device 10 acquires, as an end date and time, a current time that is generated by the timekeeping device 12 (step S6). Thus, time information including the start date and time and the end date and time is obtained. Then the control device 10 stores, as a set of recorded data, the sound signal acquired by the recording operation, the position information, and the time information in the storage device 11 (step S7).

Furthermore, the control device 10 judges whether a tag assignment instruction of the user has been detected by the touch panel display TP1 (step S8). The user can assign a tag to recorded data as a group identifier for grouping of recorded sound signals. For example, the same tag can be assigned to sound signals emitted from the same sound emitting source S0 and corresponding to the same musical piece. The same tag can be assigned to sound signals recorded on the same date and time and corresponding to the same musical piece or sound signals recorded on different date and times and corresponding to the same musical piece. The same tag can be assigned to sound signals that are judged high in similarity by a similarity analysis.

If a tag assignment instruction has been detected, the control device 10 assigns tags to the recorded data stored in the storage device 11 (step S9). If no tag assignment instruction has been detected, the control device 10 moves to step S10.

At step S10, the control device 10 judges whether a sound signal edit manipulation of the user has been detected by the touch panel display TP1. If an edit manipulation has been detected, the control device 10 edits the corresponding sound signal (step S11). At this time, an edit screen including a waveform of the sound signal and other information is displayed on the touch panel display TP1. The user can perform an edit manipulation on the sound signal through the edit screen. Example edit manipulations on a sound signal are volume adjustment and addition of a sound effect. For example, as an edit manipulation, the volume of a sound signal can be adjusted by enlarging or reducing a recording mark 300 in the map image 200 using two fingers. Alternatively, the volume of a sound signal can be adjusted by moving a finger around a recording mark 300 clockwise or counterclockwise while touching the screen. If it is judged at step S10 that no edit manipulation has been detected, the control device 10 moves to step S12.

At step S12, the control device 10 judges whether a re-recording instruction of the user has been detected by the touch panel display TP1. If a re-recording instruction has been detected, the control device 10 returns to step S1.

If it is judged at step S12 that no re-recording instruction has been detected, the control device 10 judges whether a recording data transmission instruction of the user has been detected by the touch panel display TP1 (step S13). If no transmission instruction has been detected, the control device 10 returns to step S12. If a transmission instruction has been detected, the control device 10 causes the communication device 19 to send the recorded data to the database 2 (step S14) and returns to step S12.

### (6) Operation of Synchronous Mixing Apparatus 3

FIG. 8 is a flowchart illustrating a synchronous mixing process of the synchronous mixing apparatus 3. First, the control device 30 shown in FIG. 3 causes the touch panel display TP2 to display a predetermined range of a map image (step S21). The predetermined range of the map image can be either a range including a position where the synchronous mixing apparatus 3 exists or a range that is displayed at the end of the preceding execution of the synchronous mixing process.

The control device 30 judges whether a display range changing manipulation of a user has been detected by the touch panel display TP2 (step S22). If a display range changing manipulation has been detected, the control device 30 causes the touch panel display TP2 to display a changed range of the map image (step S23). If no display range changing manipulation has been detected, the control device 30 moves to step S24.

The control device 30 acquires recorded data having pieces of position information indicating positions inside the display range of the map image (step S24), respectively, and causes the touch panel display TP2 to display recording marks corresponding to the pieces of position information concerned in the map image (step S25). For example, as shown in FIG. 6A, a plurality of recording marks 300 are displayed in the range of a map image 200.

In this state, the control device 30 judges whether specifying of an extraction condition by the user has been detected by the touch panel display TP2 (step S26). If no specifying of an extraction condition has been detected, the control device 30 moves to step S29.

If specifying of an extraction condition has been detected, the control device 30 extracts recorded data according to the extraction condition (step S27). A time range can be specified as an extraction condition. In this case, recorded data including respective pieces of time information in the specified time range can be extracted. This makes it possible to extract a plurality of recorded data that are recorded on the same date and time in the case where recording is performed a plurality of times at the same place. If a plurality of time ranges are specified by the user, sets of recording marks of recorded data whose pieces of time information belong to the respective time ranges can be displayed in layers of different colors.

A tag can be specified as an extraction condition. In this case, a tag list is displayed on the touch panel display TP2. This makes it possible to extract recorded data that belongs to the same group. Where tags are assigned by a similarity analysis, recorded data of musical pieces that are high in similarity can be extracted. When the same musical piece is recorded a plurality of times, recorded data of that musical piece can be extracted.

Then the control device 30 updates recording marks to be displayed in the map image based on the pieces of position information of the extracted recorded data (step S28). For example, recording marks 300 corresponding to the extracted recorded data are displayed in the manner shown in FIG. 6B.

Then the control device 30 judges whether a sound signal edit manipulation of a user has been detected by the touch panel display TP2 (step S29). If an edit manipulation has been detected, the control device 30 edits the corresponding sound signal (step S30). At this time, an edit screen including a waveform of the sound signal and other information is displayed on the touch panel display TP2. The user can perform an edit manipulation on the sound signal through the edit screen. If no edit manipulation has been detected, the control device 30 moves to step S31. When the user performs an edit manipulation, the sound signal can be reproduced to urge the user to make an auditory check.

At step S31, the control device 30 judges whether recording mark selection manipulations of the user has been detected by the touch panel display TP2. The user can select, as mixing targets, some of the plurality of recording marks displayed in the map image on the touch panel display TP2. If recording mark selection manipulations have been detected, the control device 30 selects the recorded data corresponding to the selected recording marks (step S32). When a recording mark has been selected, the sound signal of the recorded data corresponding to the selected recording mark can be reproduced to urge the user to make an auditory check. If no recording mark selection manipulations have been detected, the control device 30 selects, as mixing targets, the recorded data that are extracted at step S27. If no recorded data are extracted at step S27, the control device 30 selects, as mixing targets, the recorded data that are acquired at step S24.

Subsequently, the control device 30 judges whether a synchronous mixing instruction of the user has been detected by the touch panel display TP2 (step S33). If a synchronous mixing instruction has been detected, the control device 30 performs synchronous mixing processing (step S34). At this time, the sound signals of the plurality of selected recorded data are synchronized with each other based on their pieces of time information and mixed together. The sound signals can be synchronized with each other according to a common procedure that uses correlations between the sound signals. Furthermore, the accuracy of synchronization can be increased using a sampling frequency correction technique. A mixed sound signal is stored in the storage device 31. If no synchronous mixing instruction has been detected, the control device 30 moves to step S35.

At step S35, the control device 30 judges whether a reproduction instruction of the user has been detected by the touch panel display TP2. If a reproduction instruction has been detected, the control device 30 causes the sound emitting device 14 to reproduce, as a sound, the mixed sound signal that is stored in the storage device 31 (step S36). If no reproduction instruction has been detected, the control device 30 moves to step S37.

At step S37, the control device 30 judges whether an end instruction of the user has been detected by the touch panel display TP2. If no end instruction has been detected, the control device 30 returns to step S21. If an end instruction has been detected, the control device 30 finishes the synchronous mixing process.

### (7) Advantageous Effects of Embodiment

In the sound signal processing system 100 according to the embodiment, a plurality of recording marks indicating recording positions of sound signals, respectively, are displayed in a map image. A user can select, visually and easily, a plurality of sound signals to be subjected to mixing from the plurality of sound signals using the plurality of recording marks in the map image.

At this time, a user can do narrowing down recorded data as a selection target easily by appropriately specifying an extraction condition. In particular, a user can do narrowing down recorded data as a selection target to recorded data acquired in a desired time slot or recorded data belonging to a desired group. This facilitates synchronization and mixing of desired sound signals.

### (8) Other Embodiments

Although in the above embodiment the synchronous mixing apparatus 3 is employed as a sound signal processing apparatus, one of the plurality of terminal apparatuses 1 can be employed as a sound signal processing apparatus. In this case, the recording device 11 of the one terminal apparatus 1 can be used in place of the database 2. Although in the above embodiment the terminal apparatus 1 performs data acquisition processing and the synchronous mixing apparatus 3 performs synchronous mixing processing, another configuration is possible where a server performs part of data acquisition processing and/or synchronous mixing processing. Furthermore, the terminal apparatus 1 can be supplied with the data acquisition processing program and perform data acquisition processing by running it. Still further, the synchronous mixing apparatus 3 or a server can be supplied with the synchronous mixing processing program as a web program and perform synchronous mixing processing by running it.

Although in the above embodiment the plurality of terminal apparatuses 1 operate asynchronously, they can operate synchronously. For example, a recording start instruction and a recording end instruction can be transmitted between the plurality of terminal apparatuses 1 by their communicating with each other. In this case, recording start instructions and recording end instructions can be transmitted so that pieces of recording start timing and pieces of recording end timing are synchronized with each other. This facilitates synchronous mixing processing on a plurality of sound signals. Pieces of recording start timing and pieces of recording end timing need not be in strict coincidence. Where they are not in strict coincidence, a plurality of sound signals are synchronized with each other based on correlations between pieces of time information or the sound signals.

Although in the above embodiment the synchronous mixing processing program is run as one mode of a sound signal processing program, the sound signal processing program is not limited to the synchronous mixing processing program employed in the embodiment. The sound signal processing program is a program that causes a computer to execute an acquiring step of acquiring a plurality of sound signals representing sounds recorded at a plurality of positions in a sound space so that the plurality of sound signals are correlated with pieces of position information indicating the recording positions, respectively; a selecting step of selecting, as a mixing target, sound signals from the plurality of acquired sound signals based on the plurality of acquired pieces of position information; and a mixing step of mixing together the selected sound signals.

The synchronous mixing processing program can be provided not only being stored in the storage device 31 employed in the embodiment but also being stored in any of various recording media such as a digital versatile disc (DVD), a flash memory, and a memory card.

### (9) Correspondence Between Constituent Elements of Claims and Devices or Units Employed in Embodiment

Although example correspondence between the constituent elements of the claims and devices and units employed in the embodiment is explained, the present invention is not limited to the following example.

In the above embodiment, the control device 30 and the communication device 35 are an example of acquiring means, the control device 30 and the touch panel display TP2 are an example of selecting means, and the control device 30 is an example of mixing means. The touch panel display TP2 is an example of each of presenting means, manipulation detecting means, display means, and setting means, and the control device 30 is an example of each of sound signal selecting means and extracting means.

The acquiring unit 310 is an example of acquiring means; the display unit 320, the manipulation detection unit 360, and the sound signal selection unit 340 are an example of selecting means; the mixing unit 380 is an example of mixing means; the display unit 320 is an example of presenting means or display means; the manipulation detection unit 360 is an example of manipulation detecting means; the sound signal selection unit 340 is an example of sound signal detecting means; the extraction unit 330 is an example of extracting means; and the setting unit 370 is an example of setting means.

Any of various other elements having the configuration-related feature or the function that is set forth in each claim as of each constituent element of it can be used.

The present apparatus and method can be used for, for example, synchronous mixing processing for a plurality of sound signals recorded at a plurality of positions in a sound space.

### (10) Some Aspects of the Present Invention

A sound signal processing apparatus according to a first aspect includes: acquiring means that acquires a plurality of sound signals representing sounds recorded at a plurality of positions in a sound space, respectively, in such a manner that the plurality of sound signals are correlated with pieces of position information indicating the recording positions, respectively; selecting means that selects, as a mixing target, sound signals from the plurality of sound signals acquired by the acquiring means based on the plurality of pieces of position information acquired by the acquiring means; and mixing means that mixes together the sound signals selected by the selecting means.

In this sound signal processing apparatus, a plurality of sound signals representing sounds recorded at a plurality of positions in the sound space are acquired so as to be correlated with respective position information. This makes it possible to select from the plurality of sound signals easily based on the plurality of pieces of position information and to mix the selected sound signals together.

The selecting means can include: presenting means which presents the plurality of pieces of position information acquired by the acquiring means; manipulation detecting means that detects a manipulation of selecting from the plurality of pieces of position information presented by the presenting means; and sound signal selecting means that selects a sound signal corresponding to selected position information in response to detection of the selecting manipulation. With this configuration, a user can select, as a mixing target, sound signals easily based on the plurality of presented pieces of position information.

The presenting means can include display means that displays a map image and displays the plurality of pieces of position information in the map image, and the manipulation detecting means can detect a manipulation of selecting from the plurality of pieces of position information in the map image. With this configuration, the user can select, visually and easily, sound signals acquired in the same sound space, based on the plurality of pieces of position information displayed in the map image.

The sound signal processing apparatus can further include: setting means that sets a sound signal extraction condition; and extracting means which extracts a sound signal and position information that satisfy the extraction condition from the plurality of sound signals and the plurality of pieces of position information acquired by the acquiring means, and the presenting means can present the position information extracted by the extracting means. In this case, since the sound signal that satisfies the extraction condition is extracted, narrowing down of sound signal and position information as a selection target is enabled by appropriately setting the extraction condition.

The acquiring means can acquire time information indicating a recording time for each sound signal, in such a manner that the time information is correlated with the sound signal; the setting means can set a time condition relating to a sound recording time as the extraction condition; and the extracting means can extract a sound signal and position information that correspond to time information that satisfies the time condition. In this case, narrowing down of sound signal and position information as a selection target to sound signal and position information acquired in a desired time slot is enabled. This facilitates synchronization and mixing of the selected sound signals.

The selecting means can reproduce a selected sound signal in selecting the sound signal. In this case, since the sound of each sound signal is reproduced in narrowing down the sound signal as a selection target, it is possible to urge the user to check it in an auditory manner.

A sound signal processing method for a sound signal processing apparatus according to a second aspect can include the steps of: acquiring a plurality of sound signals representing sounds recorded at a plurality of positions in a sound space, respectively, so that the plurality of sound signals are correlated with pieces of position information indicating the recording positions, respectively; selecting, as a mixing target, sound signals from the plurality of sound signals based on the plurality of pieces of position information; and mixing together the selected sound signals.

In this sound signal processing method, a plurality of sound signals representing sounds recorded at a plurality of positions in the sound space are acquired so as to be correlated with respective position information. This makes it possible to select from the plurality of sound signals easily based on the plurality of pieces of position information and to mix the selected sound signals together.

The selecting step of the sound signals can include the steps of: presenting the plurality of pieces of position information; detecting a manipulation of selecting from the plurality of pieces of position information; and selecting a sound signal corresponding to selected position information in response to detection of the selecting manipulation. A user can select mixing target sound signals easily based on the plurality of presented pieces of position information.

The presenting step can display a map image and the plurality of pieces of position information in the map image, and the detecting step can detect a manipulation of selecting from the plurality of pieces of position information in the map image. The user can select, visually and easily, sound signals acquired in the same sound space, based on the plurality of pieces of position information displayed in the map image.

A sound signal extraction condition can be set; and a sound signal and position information that satisfy the set extraction condition can be extracted from the plurality of sound signals and the plurality of pieces of position information. The presenting step can present the extracted pieces of position information. In this case, since the sound signal that satisfies the extraction condition is extracted, narrowing down of sound signals and position information as a selection target is enabled by appropriately setting the extraction condition.

Time information indicating a recording time for each sound signal can be acquired so that the time information is correlated with the sound signal; a time condition relating to a sound recording time can be set as the extraction condition; and a sound signal and position information that correspond to time information that satisfies the time condition can be extracted. In this case, narrowing down of sound signals and position information to a sound signal and position information acquired in a desired time slot is enabled. This facilitates synchronization and mixing of the selected sound signals.

A selected sound signal can be reproduced in selecting the sound signal. In this case, since the sound of each sound signal is reproduced in narrowing down sound signals as a selection target, it is possible to urge the user to check it in an auditory manner.

A sound signal processing program according to a third aspect causes a computer to execute: an acquiring step of acquiring a plurality of sound signals representing sounds recorded at a plurality of positions in a sound space, respectively, so that the plurality of sound signals are correlated with pieces of position information indicating the recording positions, respectively; a selecting step of selecting, as a mixing target, sound signals from the plurality of sound signals based on the plurality of pieces of position information; and a mixing step of mixing together the selected sound signals.

In this sound signal processing program, a plurality of sound signals representing sounds recorded at a plurality of positions in the sound space are acquired so as to be correlated with respective position information. This makes it possible to select from the plurality of sound signals easily based on the plurality of pieces of position information and to mix the selected sound signals together.

Reference signs are listed as follows:
1: Terminal apparatus;
2: Database;
3: Synchronous mixing apparatus;
10, 30: Control device;
11, 31: Storage device;
12: Timekeeping device;
13: Sound pick-up device;
14, 32: Sound emitting device;
15, 33: Display device;
16, 34: Input device;
17: Position sensor;
18: Imaging device;
19, 35: Communication device;
100: Sound signal processing system;
310: Acquiring unit;
320: Display unit;
330: Extraction unit;
340: Sound signal selection unit;
350: Storage unit;
360: Manipulation detection unit;
370: Setting unit;
380: Mixing unit;
S0: Sound emitting source;
TP1, TP2: Touch panel display.

What is claimed is:

1. A sound signal processing apparatus comprising:
a control device including a memory storing instructions and a processor configured to implement the instructions stored in the memory and execute:
an acquiring task that acquires a plurality of sound signals representing sounds recorded at a plurality of positions in a sound space, respectively, and correlates the acquired plurality of sound signals with a plurality of pieces of position information indicating the recording positions, respectively;
a selecting task that selects, as a mixing target, sound signals from among the acquired plurality of sound signals correlated with the plurality of pieces of position information; and
a mixing task that mixes together the selected sound signals to be synchronized with each other.

2. The sound signal processing apparatus according to claim 1, wherein the selecting task:
presents the plurality of pieces of position information;
detects a manipulation of selection from among the presented plurality of pieces of position information; and
selects a sound signal corresponding to selected position information, from among the presented plurality of pieces of position information, in response to detection of the selection manipulation.

3. The sound signal processing apparatus according to claim 2, wherein the selecting task:
displays the presented plurality of pieces of position information in a map image; and
in detecting the manipulation of selection, detects a manipulation of selection, from among the presented plurality of pieces of position information, in the map image.

4. The sound signal processing apparatus according to claim 2, wherein:
the processor is further configured to execute:
a setting task that sets a sound signal extraction condition; and
an extracting task that extracts a sound signal and position information that satisfy the extraction condition from among the plurality of sound signals and the presented plurality of pieces of position information, and
the selecting task presents the extracted position information as the presented plurality of pieces of position information.

5. The sound signal processing apparatus according to claim 4, wherein:
the processor is further configured to execute a time acquiring task that acquires time information indicating a recording time for each sound signal, and correlates the time information with the respective sound signal,
the setting task sets a time condition relating to a sound recording time as the extraction condition, and
the extracting task extracts the sound signal and position information that satisfy the time condition.

6. The sound signal processing apparatus according to claim 1, wherein the processor is further configured to execute a reproducing task that reproduces the selected sound signal.

7. A sound signal processing method for a sound signal processing apparatus, the method comprising:
an acquiring step of acquiring a plurality of sound signals representing sounds recorded at a plurality of positions in a sound space, respectively, and correlating the acquired plurality of sound signals with a plurality of pieces of position information indicating the recording positions, respectively;
a selecting step of selecting, as a mixing target, sound signals from among the plurality of sound signals correlated with the plurality of pieces of position information; and
a mixing step of mixing together the selected sound signals to be synchronized with each other.

8. The sound signal processing method according to claim 7, wherein the selecting step:
presents the plurality of pieces of position information;
detects a manipulation of selection from among the plurality of pieces of position information; and
selects a sound signal corresponding to selected position information, from among the presented plurality of pieces of position information, in response to detection of the selection manipulation.

9. The sound signal processing method according to claim 8, wherein the selecting step:
displays the presented plurality of pieces of position information in a map image; and
in detecting the manipulation of selection, detects a manipulation of selection, from among the presented plurality of pieces of position information, in the map image.

10. The sound signal processing method according to claim 8, further comprising:
a setting step of setting a sound signal extraction condition; and
an extracting step of extracting a sound signal and position information that satisfy the set extraction condition from among the plurality of sound signals and the presented plurality of pieces of position information,
wherein the selecting step presents the extracted pieces of position information as the presented plurality of pieces of position information.

11. The sound signal processing method according to claim 10, further comprising:
a time acquiring step of acquiring time information indicating a recording time for each sound signal, and correlating the time information with the respective sound signal,
wherein the setting step sets a time condition relating to a sound recording time as the extraction condition, and
wherein the extracting step extracts the sound signal and position information that satisfy the time condition.

12. The sound signal processing method according to claim 7, further comprising a reproducing step of reproducing the selected sound signal.

13. A sound signal processing system comprising:
a plurality of terminal apparatuses; and
a sound signal processing apparatus,
wherein the sound processing apparatus comprises:
a control device including a memory storing instructions and a processor configured to implement the instructions stored in the first memory and execute:
an acquiring task that acquires a plurality of sound signals representing sounds recorded at a plurality of positions in a sound space, respectively, from the plurality of terminal apparatuses, and correlates the acquired plurality of sound signals with a plurality of pieces of position information indicating the recording positions acquired from the plurality of terminal apparatuses, respectively;
a selecting task that selects, as a mixing target, sound signals from among the acquired plurality of sound signals correlated with the plurality of pieces of position information; and
a mixing task that mixes together the selected sound signals to be synchronized with each other.
